(19) United States
(12) Patent Application Publication
(10) Pub. No.: US 2018/0071950 A1
(43) Pub. Date: Mar. 15, 2018

(54) METHOD OF MANUFACTURING A HEAT EXCHANGER

(71) Applicant: HAMILTON SUNDSTRAND CORPORATION, Charlotte, NC (US)

(72) Inventors: Gavin Charles Richards, Windsor, CT (US); Kiley James Versluys, Hartford, CT (US)

(21) Appl. No.: 15/262,945

(22) Filed: Sep. 12, 2016

(51) Int. Cl. B28B 1/30; B28B 7/34; B28B 7/00; B28B 7/28; F28F 21/04; F28D 9/00

(52) U.S. Cl. CPC B28B 1/30; B28B 7/346; B28B 7/342; F28D 9/0037; B28B 7/28; F28F 21/04; B28B 7/0064

(57) ABSTRACT

A method of making a heat exchanger is disclosed that includes identifying a space for a heat exchanger fluid flow path. A carbon template is formed in the shape of the flow path space, with void space in the shape of a fluid guide that forms the flow path space. A ceramic or a ceramic precursor fluid composition is deposited to the template void space, and a solid ceramic is formed from the fluid composition. The template is removed by oxidizing the carbon.

### BACKGROUND

This disclosure relates to generally heat exchangers and other fluid guides and more particularly to methods of manufacturing such articles.

Heat exchangers are devices built for transferring heat from a heat source to a heat sink. This transfer of heat often utilizes fluids (e.g., air, water, or organic compound or composition), either as a heat transfer medium or as the principal heat source or heat sink. The fluids may be separated by a solid barrier or other divider that keeps them from mixing. Heat exchangers are commonly used in refrigeration, air conditioning, space heating, electricity generation, and chemical processing. Heat exchangers are typically designed to provide a high surface area of the barrier between the two fluids, while minimizing resistance to fluid flow through the heat exchanger. The performance of the heat exchanger may also be affected by the addition of fins, corrugations or other forms of protuberances in one or both flow directions which increase surface area, channel fluid flow, and induce turbulence.

The manufacture of heat exchangers typically involves complex assembly and multiple steps of attachment, brazing, soldering, or welding operations of various metal heat exchanger components, including but not limited to the core, the exterior, fins, and manifolds. Additionally, many heat exchanger designs and methods for manufacture necessitate the use of metal parts, which may not be suited for certain environments such as corrosive or high temperature environments.

### BRIEF DESCRIPTION

According to some embodiments of this disclosure, a method of making a heat exchanger comprises identifying a space for a heat exchanger fluid flow path. A template comprising carbon is formed in the shape of the flow path space, with void space in the shape of a fluid guide that forms the flow path space. A fluid composition comprising ceramic or a ceramic precursor is deposited to the template void space, and a solid ceramic is formed from the fluid composition. The template is removed by oxidizing the carbon.

According to some embodiments, a method of making a fluid guide comprises identifying a space for a fluid flow path. A template comprising carbon is formed in the shape of the flow path space, with void space in the shape of the fluid guide. A fluid composition comprising ceramic or a ceramic precursor is deposited to the template void space, and a solid ceramic is formed from the fluid composition. The template is removed by oxidizing the carbon.

### BRIEF DESCRIPTION OF THE DRAWINGS

Subject matter of this disclosure is particularly pointed out and distinctly claimed in the claims at the conclusion of the specification. The foregoing and other features, and advantages of the present disclosure are apparent from the following detailed description taken in conjunction with the accompanying drawings in which:

FIGS. 1A and 1B are schematic depictions of a perspective view and end view, respectively, of a template for a heat exchanger;

FIGS. 2A and 2B are schematic depictions of a perspective view and end view, respectively, of a composite structure comprising the FIG. 1 deposited with a fluid ceramic composition; and

FIGS. 3A and 3B are schematic depictions of a perspective view and end view, respectively, of a heat exchanger structure after removal of the template from the composite FIG. 2 composite structure.

### DETAILED DESCRIPTION

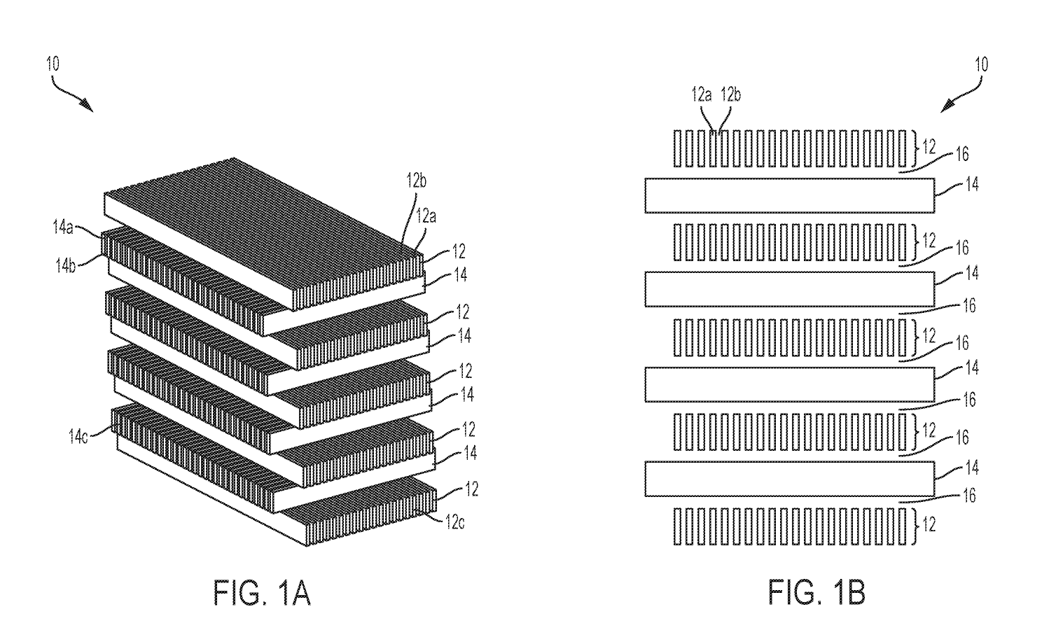

With reference now to the Figures, FIGS. 1A and 1B represent a schematic depiction of a carbon template 10 that can be used to fabricate a plate fin heat exchanger. As shown in FIGS. 1A and 1B, a plurality of template courses 12 and 14 are arranged in a layup configuration alternating between the configuration of template course 12 and the configuration of template course 14. Each template course 12, 14 comprises a plurality of template structures 12a, 14a corresponding to with void spaces 12b, 14b between the template structures. The void spaces 12b, 14b correspond to fin structures in the heat exchanger, and the spaces occupied template structures 12a, 14b correspond to flow pathways between the fin structures. As shown in FIG. 1B, the template layup structure includes spaces 16 between the template structures 12a and 14a, which correspond to plates in the fin plate heat exchanger. This spacing can be maintained by an external framework (not shown) temporarily connected to the ends 12c, 14c of the template structures 12a, 14a, which can be removed after formation of a solid ceramic in the template void spaces. Alternatively, plate structures comprising a ceramic or ceramic precursor (not shown) can be in included in the layup in the regions of the spaces 16.

As mentioned above, the template comprises carbon. Various types of carbon-containing materials can be used, including but not limited to graphite or amorphous carbon. In some embodiments, the template material can be prepared by mixing carbon powder with a resin binder (e.g., 30 to 80 weight percent (based on total weight of carbon powder and binder) of a binder such as coal tar pitch, petroleum pitch, synthetic polymer resins) to form an extrudable or moldable material, and extruding or molding the material into the shape of the desired template structures. The molded material can optionally be cured with heat (e.g., 100-250° C.) to graphitize the carbon. Other carbon-containing template materials can be used as well. For example, wood materials or organic resins also contain carbon atoms, and can be used with lower temperature deposition processes such as sol-gel processes, discussed in greater detail below. In some embodiments, a larger piece of graphite could be machined into a more complex geometry if extruding it would be difficult. The template material can include additives or surface treatments that may promote deposition of the ceramic. For example, the template can include atomic content matching portions of the ceramic (e.g., silicon content), such as ceramic or ceramic precursor material (e.g., particles or layer) on or near the surface to promote formation of an interphase layer. In some embodiments, the template can be coated with a thin ceramic layer using chemical vapor deposition (CVD), or other thin film technique to help protect the carbon template from the harsher processing methods.

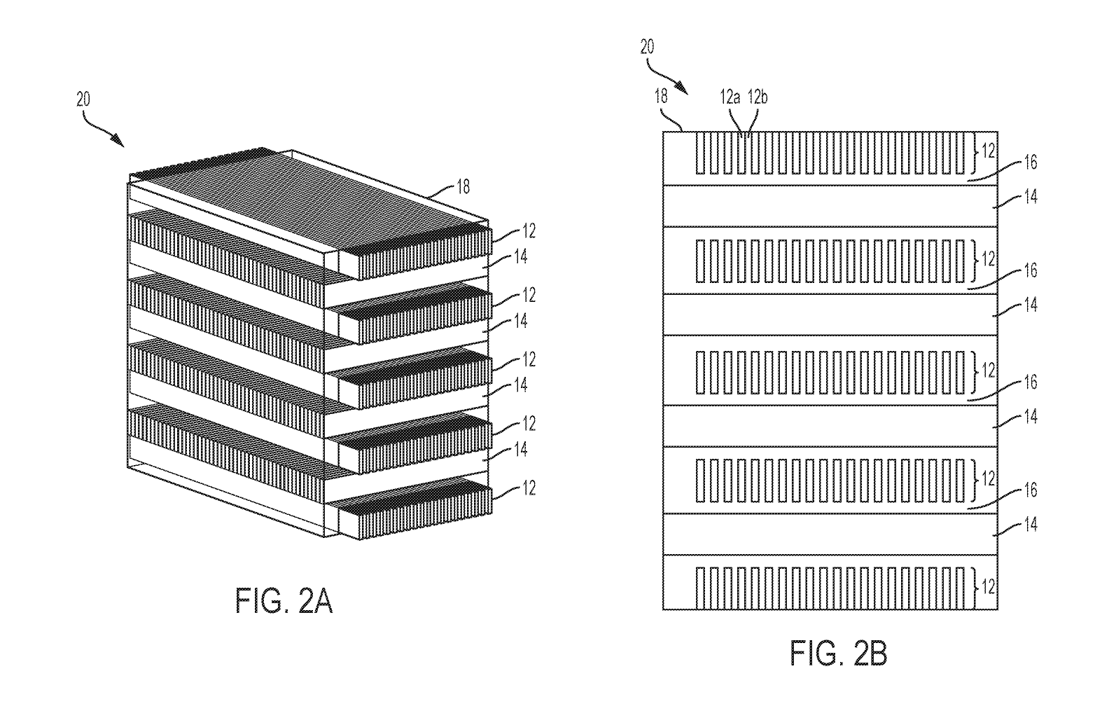

With reference now to FIGS. 2A and 2B, it is shown that a ceramic material 18 has been deposited into the spaces between the template structures 12a, 14a to form a composite structure 20 comprising the template 10 (FIG. 1) and the ceramic material 18. Any type of ceramic material can be used with various embodiments disclosed herein, and the material selection can be influenced by factors such as on target properties of the heat exchanger and selection processing parameters. Examples of ceramic materials include ceramic carbides including but not limited to silicon carbide, boron carbide, titanium carbide, and zirconium carbide, ceramic nitrides including but not limited to aluminum nitride and silicon nitride, ceramic oxides including but not limited to aluminum oxide, silicon dioxide, and titanium dioxide.

The ceramic material can be deposited or infiltrated into the template and densified by various techniques. Various ceramic deposition or infiltration processes and methodologies can be used. These include, but are not limited to, chemical vapor infiltration (CVI), polymer impregnation and pyrolysis (PIP), melt infiltration (MI), or sol-gel processing. Chemical vapor infiltration involves utilizing vapor deposition to apply a ceramic precursor to the template that is chemically transformed during the deposition process into a ceramic material. Examples of CVI ceramic precursors for ceramics include but are not limited to methyltrichlorosilane with hydrogen gas (for deposition of silicon carbide), boron trichloride and methane with hydrogen gas for deposition of boron carbide or titanium tetrachloride, methane with hydrogen gas for titanium carbide, silicon tetrachloride and ammonia gas for silicon nitride, aluminum isopropoxide for the deposition of aluminum oxide, or tetraethylorthosilicate for the deposition of silicon dioxide. CVI can be performed by introducing a carrier gas comprising the precursor composition into a heated space (e.g., an oven). This isothermal/isobaric process is also known as the “hot wall” technique. CVI can also be performed under non-isothermal conditions where the template is subjected to a temperature gradient and is infiltrated with a forced gas flow. CVI can be performed under reduced pressure or a vacuum, or at atmospheric pressure. Process variations commonly employed for chemical vapor deposition (CVD) can also be utilized for CVI, including but not limited to aerosol assist for the infiltrating gas flow, plasma assist for the infiltrating gas flow, or direct liquid injection (where liquid precursors are injected to a vaporization chamber prior to infiltration into the template).

Polymer impregnation and pyrolysis involves the introduction of a liquid composition comprising a pre-ceramic polymer into the template void space, followed by pyrolysis to convert the pre-ceramic polymer to a solid ceramic. Several subsequent polymer infiltration and pyrolysis cycles (6 to 11) are typically required to bring the ceramic to full density. Examples of pre-ceramic polymers include but are not limited to polycarbosilane (for deposition of silicon carbide), polysilazanes (for deposition of silicon nitride), and polysiloxanes (for deposition of silicon dioxide). The liquid composition can be introduced to the template void spaces using various known liquid molding, injection, infiltration, or other liquid processing techniques. Examples of methods for introducing the liquid composition to the template void spaces include immersion of the template into the liquid composition, injection of liquid into the template void spaces, vacuum transfer where a vacuum is utilized to draw the liquid into the template void spaces by evacuating air from the template void spaces in the presence of the liquid pressure-driven infiltration, pressure transfer where a pressure differential drives higher pressure liquid metal into the spaces in the pre-form. Combinations of these methods can be used as well. For example, the liquid can be injected under pressure into the template void spaces from one side of the template (e.g., the side 12c, 14c (FIGS. 1-3)) while a vacuum is drawn from the opposite side of the template (e.g., the side opposite to 12c, 14c (FIGS. 1-3)). In some embodiments, additional manipulations can be applied to promote infiltration of the liquid into the template void spaces, including but not limited to application of vibration (including ultrasonic vibration) to the liquid or template, or pulsation of pressure or vacuum. After deposition of the liquid into the template void spaces, the liquid preceramic polymer can be cured to solidify the polymer, and pyrolyzed to convert the preceramic polymer to ceramic. The pre-ceramic polymer can also be mixed with ceramic particles (with loadings up to 60% by weight or ceramic particulate material, based on the total weight of the ceramic particles and preceramic polymer) prior to introduction into the template void space to further tailor the resulting ceramic's properties. The ceramic particulate can include, but is not limited to, any of the aforementioned ceramic materials.

Melt infiltration involves the introduction of a liquid composition comprising a carbonaceous precursor into the template void space, followed by pyrolysis to convert the carbonaceous material to a solid carbon. Molten silicon metal is then introduced to the material, reacting with the carbonaceous material to form silicon carbide. For example, a liquid phenolic resin can be injected and then cured to surround the carbon fluid flow path template. The composite material would then be packed with a silicon metal and phenolic resin cover mixture, placed in a vacuum furnace, and heated above the melting point of silicon (1414° C.). The silicon melts, diffusing in to the composite and reacting with the cured phenolic resin to form the silicon carbide ceramic. For another example, the carbon fluid flow path template could be partially densified with carbon using CVI. The resulting partial composite structure can then be covered with a silicon metal and phenolic resin cover mix and heated under vacuum like the prior example. In some embodiments, the liquid composition can comprise carbon (e.g., a slurry of carbon powder, a carbonaceous resin, or a gaseous carbon species in the case of CVI). The liquid composition can be introduced to the template void spaces using various known liquid molding, injection, infiltration, or other liquid processing techniques. Examples of methods for introducing the liquid composition to the template void spaces include immersion of the template into the liquid composition, injection of liquid into the template void spaces, vacuum transfer where a vacuum is utilized to draw the liquid into the template void spaces by evacuating air from the template void spaces in the presence of the liquid pressure-driven infiltration, pressure transfer where a pressure differential drives higher pressure liquid metal into the spaces in the pre-form. Gaseous deposition methods such as CVI can also be used to deposit a carbon layer. Since the molten silicon will react with any carbon materials, this processing method can include applying a thin ceramic coating later to the carbon fluid flow path template. This layer can comprise a material resistant to attack by molten silicon, such as silicon carbide, titanium carbide, or boron nitride.

Sol-gel processing can also be used to introduce the ceramic into the template void spaces. Sol-gel formation of ceramics utilizes a ceramic precursor dissolved or in stable suspension in a liquid carrier (i.e., the “sol”). A chemical change is induced to this liquid carrier system that causes the ceramic precursor to drop out of the solution or suspension (the “gel”). The gelled coating can then be further dried and pyrolyzed to form a ceramic material. As applied herein, the liquid sol can be introduced to the template void spaces, followed by introduction of the chemical change to form the solid ceramic and subsequent drying to remove residual liquid. For example, a ceramic precursor such as an alkoxide or a metal alkoxide can undergo hydrolysis in an aqueous liquid comprising a miscible organic solvent to form a sol comprising a metal alkoxide or metal hydroxide. A chemical change (e.g., dilution of the miscible solvent with additional water or addition of an acid or base to cause a pH change) is used to initiate a polycondensation reaction of the metal alkoxide or metal hydroxide, resulting in the formation of a metal oxide or metal oxide amorphous structure. The condensed metal alkoxide is then dried and heated to from the crystalline ceramic material. Additional ceramic content can be incorporated into a sol-gel ceramic by inclusion of a source of a ceramic powder in the sol mixture (e.g., aluminum oxide or silicon dioxide powder) that is incorporated into domains (e.g., nanoscopic domains) dispersed in the gel phase such as a silica gel phase, followed by condensation and heating to form the ceramic monolith. Sol-gel processing lends itself to the formation of oxide ceramic materials such as aluminum oxide, silicon dioxide, or titanium dioxide.

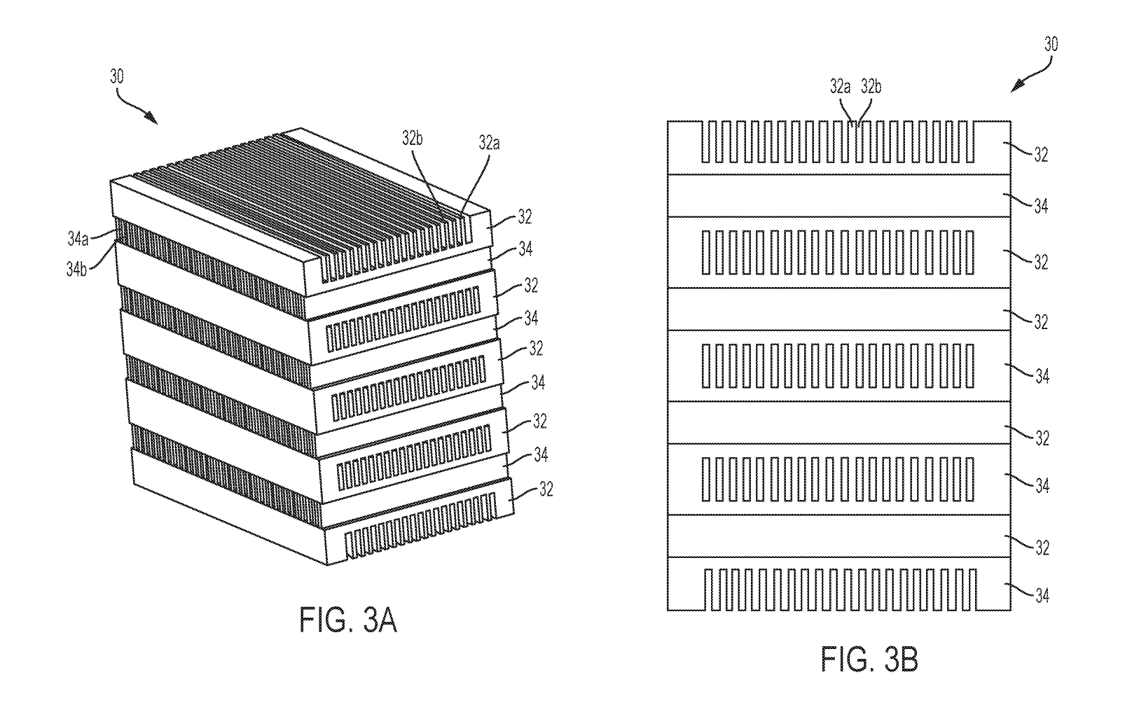

Deposition and densification of the solid ceramic into the template void spaces produces the composite structure 20 comprising the carbon template and the deposited ceramic. The template is then removed to form the plate fin heat exchanger structure 30 in FIGS. 3A and 3B. As shown in FIGS. 3A and 3B, the heat exchanger structure 30 includes a first side (e.g., one of a heat absorption side or a heat rejection side) flow path through heat exchanger structures 32, with the fluid flow path extending through the channel spaces 32b between the fins 32a. The plate fin heat exchanger structure 30 includes a second side (e.g., the other of the heat absorption side or heat rejection side) flow path through heat exchanger structures 34, with the fluid flow path extending through the channel spaces 34b between the fins 34a. The carbon template can be removed by pyrolysis techniques in which the carbon is oxidized to form carbon dioxide and carbon monoxide gas. Other components such as residual organic compounds or polymer from formation of the template can also be combusted to form gaseous components for removal. Oxidation of the carbon template for removal can be performed at temperatures of 350-1000° C. in either ambient air in a conventional atmospheric furnace or under flowing oxygen in a vacuum furnace. Additional heat exchanger components (not shown), including but not limited to inlet and outlet manifolds, external housing structures, mounting structures and components, sensor ports, baffles, etc., can be incorporated into the template configuration or can be connected to the structure 30 utilizing conventional attachment or bonding techniques.

The above description is of a particular example embodiment for a particular heat exchanger design, and can be subject to various modifications and changes. For example, the example embodiment in FIGS. 1-3 depicts forming a single template configuration and depositing ceramic in the void spaces to form a single contiguous ceramic structure. One example of an alternative approach would be to form separate templates corresponding to each course of a plate fin heat exchanger, deposit and densify the ceramic to form multiple composite structures corresponding to the courses of the heat exchanger, assemble the multiple courses using conventional bonding techniques, and removing the templates by oxidizing the carbon. Another example of an alternative approach would be to form separate templates corresponding to each course of a plate fin heat exchanger, deposit and densify the ceramic to form multiple composite structures corresponding to the courses of the heat exchanger, remove the templates by oxidizing the carbon to form multiple ceramic structures corresponding to the courses of the heat exchanger, and assemble the multiple courses using conventional bonding techniques. Also, the methods describe herein have related to a plate fin heat exchanger, but can also be used to fabricate other heat exchanger configurations such as shell-and-tube or other types of plate configurations for heat exchangers. Additionally, while the methods disclosed herein have been applied to form fluid guides in heat exchangers, they can also be applied to other fluid guides such as pipes and other conduits, pump components, valves, fluid guides having a wall thickness of at least 100 μm, fluid guides having a flow channel width or diameter of at least 100 μm, or fluid guides with extended geometries such as fluid guides comprising a plurality of fluid flow paths (with template structures corresponding to the plurality of fluid flow paths).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A method of making a heat exchanger, comprising:
identifying a space for a heat exchanger fluid flow path;
forming a template comprising carbon in the shape of the flow path space and void space in the shape of a fluid guide that forms the flow path space;
depositing a fluid composition comprising ceramic or a ceramic precursor to the template void space;
forming a solid ceramic from the fluid composition in the template void space; and
removing the template by oxidizing the carbon.

2. The method of claim 1, wherein the identified space comprises a plurality of heat exchanger fluid flow paths, and the template comprises a plurality of template structures corresponding to the plurality of fluid flow paths.

3. The method of claim 2, wherein the plurality of heat exchanger fluid flow paths includes a heat absorption side fluid flow path and a heat rejection side fluid flow path.

4. The method of claim 1, wherein the heat exchanger is a plate fin heat exchanger.

5. The method of claim 4, comprising forming and assembling a plurality of template courses comprising template structures with spaces between the first course template structures corresponding to heat exchanger fins, and removing the template structures by oxidizing the carbon

6. The method of claim 4, comprising forming a plurality of templates comprising template structures with spaces between the template structures corresponding to heat exchanger fins, depositing the fluid composition comprising ceramic or ceramic precursor to the spaces between the template structures and forming the solid ceramic to form a plurality of composite structures comprising carbon and ceramic, assembling the composite structures as courses of the plate fin heat exchanger, and removing the template structures by oxidizing the carbon.

7. The method of claim 4, comprising forming a plurality of templates comprising template structures with spaces between the template structures corresponding to heat exchanger fins, depositing the fluid composition comprising ceramic or ceramic precursor to the spaces between the template structures and forming the solid ceramic to form a plurality of composite structures comprising carbon and ceramic, removing the template structures from the composite structures by oxidizing the carbon to form a plurality of ceramic structures comprising heat exchanger fins, and assembling the ceramic structures as courses of the plate fin heat exchanger.

8. The method of claim 1, wherein the template comprises carbon powder and a resinous binder.

9. The method of claim 7, wherein forming the template comprises molding or extruding the carbon powder and resinous binder.

10. The method of claim 1, wherein the fluid composition comprises a ceramic carbide or a ceramic carbide precursor.

11. The method of claim 10, wherein the fluid composition comprises silicon carbide or a silicon carbide precursor, boron carbide, titanium carbide, zirconium carbide, or a precursor of any of the foregoing.

12. The method of claim 1, wherein the fluid composition comprises a ceramic nitride or a ceramic nitride precursor.

13. The method of claim 12, wherein the fluid composition comprises aluminum nitride or an aluminum nitride precursor.

14. The method of claim 1, wherein the fluid composition comprises a ceramic oxide or a ceramic oxide precursor.

15. The method of claim 14, wherein the fluid composition comprises aluminum oxide or an aluminum oxide precursor.

16. The method of claim 1, wherein depositing the fluid composition comprises chemical vapor deposition of a ceramic precursor to form the solid ceramic.

17. The method of claim 1, wherein depositing the fluid composition comprises depositing a liquid composition comprising a pre-ceramic polymer, and pyrolyzing the pre-ceramic polymer to form the solid ceramic.

18. The method of claim 1, wherein depositing the fluid composition comprises depositing a liquid composition comprising a carbonaceous material, and reacting the carbonaceous material with a molten metal to form the solid ceramic.

19. The method of claim 1, wherein depositing the fluid composition comprises depositing a liquid sol comprising a ceramic precursor, and subjecting the liquid sol to gelation, drying, and heating to form the solid ceramic.

20. A method of making a fluid guide, comprising
identifying a space for a fluid flow path;
forming a template comprising carbon in the shape of the flow path space and void space in the shape of a fluid guide that forms the flow path space;
depositing a fluid composition comprising ceramic or a ceramic precursor to the template void space;
forming a solid ceramic from the fluid composition in the template void space; and
removing the template by oxidizing the carbon.
